(19) United States
(12) Patent Application Publication
(10) Pub. No.: US 2025/0384759 A1
(43) Pub. Date: Dec. 18, 2025

(54) A TASK MANAGEMENT APPLIANCE

(71) Applicant: Active Healthcare Solutions Ltd, Greater London (GB)

(72) Inventors: Geoffrey Marsh, Greater London (GB); Kiah Robinson Jarrett, Greater London (GB); Benjamin Atkinson-Willes, Greater London (GB)

(21) Appl. No.: 18/878,349

(22) PCT Filed: Jun. 27, 2023
(86) PCT No.: PCT/GB2023/051679

§ 371 Date: Dec. 23, 2024

(30) Foreign Application Priority Data
Jun. 28, 2022 (GB) 2209477.5

(51) Int. Cl. G08B 21/24; G04G 9/00; G04G 21/00; G08B 7/06

(52) U.S. Cl. CPC G08B 21/24; G04G 9/007; G04G 21/00; G08B 7/06

(57) ABSTRACT

A task management appliance configured for management of routine tasks by a person living with a cognitive impairment, including a first display configured to show an indication of the time, day, and/or date, and a second display on which a plurality of tasks are presented, wherein the task management appliance is configured to output an alarm at a pre-determined time while simultaneously providing an indication of the task to be performed by the person living with a cognitive, visual, or other sensory impairment.

### TECHNICAL FIELD

The present invention relates to a task management appliance. In particular, the present invention relates to a task management appliance for management of regular tasks by a person living with a cognitive, visual, or any other sensory impairment.

### BACKGROUND

Those living with any kind of cognitive or sensory impairment often require devices adapted for their specific needs. For example, those who have impaired hearing may use alarm clocks which ring more loudly than conventional alarm clocks, or that have a flashing light function to disrupt their sleep.

Further, known clocks for assisting those living with a cognitive impairment, or for senior care, typically comprise displays with time or date information displayed in large, bold lettering. This is due to the fact that the target users may have worsening eyesight. Such clocks also tend to avoid using abbreviated terms for the day or date, so that users do not need to process these terms.

Alternatively, there are “talking button” clocks, which function audibly and typically do not have a display. When the user presses a button, audio which tells the current time is output by a speaker of the clock. Clocks of this variety are not suitable for users with impairment to their hearing.

While clocks such as those noted above are limited in function expressly to increase their accessibility, their lack of function also reduces their usefulness to users. There is therefore a need for an improved device.

### SUMMARY OF THE INVENTION

According to a first aspect of the invention, there is provided a purpose-built task management appliance for managing routine tasks by a person living with a cognitive, visual, or other sensory impairment. The purpose-built task management appliance comprises: a first display configured to show an indication of the time, day, and/or date; and a second display on which a plurality of tasks are presented. The purpose-built task management appliance is configured to output an alarm at a pre-determined time while simultaneously providing an indication of the task to be performed by the person living with a cognitive, visual, or other sensory impairment. The task management appliance is configured to output signals to indicate progress. The signals are attributed to each of the plurality of tasks and comprise: a signal indicating that a task is outstanding; a signal indicating that a task is in progress, a signal indicating that a task has been completed; and wherein the signals to indicate progress are configured to be toggled by the person living with a cognitive, visual, or other sensory impairment.

The purpose-built task management appliance is adapted for managing routine tasks by a person living with a cognitive, visual, or other sensory impairment. The appliance is purpose-built for managing routine tasks by a person living with a cognitive, visual, or other sensory impairment, such that it does not comprise any other applications or software that can, amongst other things, increase power consumption, drain battery life, reduce the performance of the appliance, and make the appliance difficult to navigate for a person living with such conditions.

Cognitive impairments may include a number of conditions or diseases, such as age-related memory loss, Alzheimer's disease, multiple sclerosis, brain injury, brain aneurysm, stroke, schizophrenia, epilepsy, chronic fatigue syndrome, fibromyalgia syndrome, traumatic brain injury, and Parkinson's disease. Sensory impairments may include hearing, visual, physical, or mobility impairments.

The progress of tasks being indicated to the user is advantageous as users suffering from memory loss may be prone to re-performing completed tasks. By there being some indication of the progress of a task, users are aware of which tasks they do or do not need to perform. In particular, the indication that a task is “in progress” enables users to monitor tasks which require completion, thus helping to prevent them from forgetting to complete these tasks. By also making the appliance purpose-built, this mitigates the risk of the appliance losing power quickly or unexpectedly during the day (i.e., whilst one or more tasks are still in progress), which is important for users who do not have regular visits from carers who can ensure the appliance is appropriately plugged in, charged or installed with working batteries, and are able to problem solve any other issues with performance that may result from bloatware and the like. Likewise, with devices that comprise other software applications and serve other functions, a user living with a cognitive, visual, or other sensory impairment may accidentally exit the task management interface and not understand how to return, and subsequently miss important tasks as a result, causing confusion and distress.

The purpose-built task management appliance may be configured to show the indication of the time, day, and/or date simultaneously with the plurality of tasks. It will be understood that this means that the purpose-built task management appliance may be configured to show the indication of one or more of the time, day, and/or date. This is particularly advantageous for users experiencing symptoms that are caused by disorders affecting the brain and impact on memory, thinking, behaviour, and emotion, as they are often require reminders and reference points.

The alarm may comprise an audible notification. The alarm may comprise a visual notification. The alarm may comprise a haptic notification.

Audible notifications present the advantage of being detectable by users with sight impairment. Visual notifications present the advantage of being detectable with hearing impairment. Haptic notifications, advantageously, are detectable by users with either of, or both of, sight and hearing impairment. The alarm may comprise one or more of an audible, visual, and/or haptic notification. A combination of two or more of an audible notification, a visual notification, and a haptic notification can provide configurations with enhanced accessibility to users of several different sensory impairments.

The purpose-built task management appliance may comprise at least one button for toggling the progress of each task. The purpose-built task management appliance may otherwise comprise a plurality of buttons. The, or each, button may be associated with a task. With this configuration, the, or each, button may be configured to “snooze” or turn off the alarm for an associated task when pressed.

The signal may comprise a visual signal. For example, the signal may correspond to different colours. Alternatively, the signal may correspond to changing text, graphics, or any other suitable indicator. The visual signal may be configured to illuminate one or more of the plurality of buttons. For example, whilst a task is outstanding or in progress, the display may show a pop-up display area to indicate that a task is due for completion. In this respect, the pop-up display area may be displayed at a pre-determined time, or at a pre-determined period of time before the task is due to be completed. The visual signal may therefore comprise a colour signal. For example, each of the buttons may be illuminated. In some embodiments, each of the buttons may be illuminated by a coloured light. For example, the each of the buttons may be illuminated by a coloured LED. With this configuration, the signal indicating that a task is outstanding may correspond to a first colour signal; the signal indicating that a task has been completed may correspond to a second colour signal; and the signal indicating that a task is in progress may correspond to a third colour signal. In doing so, this provides a clear indication to the user as to whether a task has been completed or not, the colour signal not changing until the user has pressed the appropriate button to move the task to the next progress status, thus helping to ensure the user does not miss any important tasks such as taking medication. Alternatively, the visual signal may comprise a flashing light. The flashing light may comprise a flashing LED, for example, or any other appropriate form of flashing light. The visual signal may be provided on one or more of the plurality of buttons. Alternatively, the visual signal may clearly correspond to one or more of the plurality of buttons.

The second display on which a plurality of tasks can be displayed may be customisable. For example, the second display may comprise labels. In some arrangements, the second display on which a plurality of tasks can be displayed may comprise a paper, card, or polymer sheet on which a task can be written. The second display may otherwise be digital and configured to display a user input. This allows users to create several alarms, which are not limited to tasks assigned during manufacture. Individual users may have unique requirements for alarms which cannot be catered to in mass production, and so a customisable second display is particularly advantageous.

The purpose-built task management appliance may be configured such that the pre-determined time attributed to the task item is customisable. There may be one or more pre-determined times attributed to one or more tasks. The purpose-built task management appliance may be configured to output an alarm at the one or more pre-determined times, while simultaneously providing an indication of the task to be performed. Each of the pre-determined times may be customisable.

The first display may be provided on a face of the purpose-built task management appliance. Similarly, the second display may be provided on a face of the purpose-built task management appliance.

The purpose-built task management appliance is configured for management of regular tasks by a person living with a hearing, visual, physical, cognitive and/or mobility impairment. That is, the purpose-built task management appliance may be configured for management of regular tasks by a person living with one or more of a hearing, visual, physical, cognitive or mobility impairment. The purpose-built task management appliance may otherwise be adapted for management of regular tasks by a person living with one or more of a hearing, visual, physical, cognitive or mobility impairment.

Such configurations or adaptations typically account for the needs of these users by incorporating features which are more easily sensed. For example, louder sounds, larger and thus more easily seen displays, and higher-powered haptic outputs are suitable for those with such impairments. It will be understood that these configurations are not limited to these examples.

Further adaptations include limiting the function of the purpose-built task management appliance. The appliance is preferably configured for the specific functions as set out above. Thus, it uses little power and does not store any bloatware or other software applications in the memory that can reduce the performance of the appliance. Further, such an appliance is straightforward for use by persons living with hearing, visual, physical, cognitive or mobility impairments; and does not require significant learning or training to use.

According to a further aspect of the invention, there is provided a task management system for management of routine tasks by a person living with a cognitive, visual, or other sensory impairment. The system comprises a purpose-built hub and an auxiliary component. The purpose-built hub comprises: a display configured to show an indication of the time, day, and/or date; and a task display on which a plurality of tasks can be displayed. The purpose-built hub is configured to output an alarm at a pre-determined time and simultaneously provide an indication of the task to be performed. The purpose-built hub and/or the auxiliary component are configured to output signals to indicate progress. The signals are attributed to each of the plurality of tasks and comprise: a signal indicating that a task is outstanding; a signal indicating that a task is in progress, and a signal indicating that a task has been completed. The signals to indicate progress are configured to be toggled by the person living with a cognitive, visual, or other sensory impairment. The auxiliary component is configured to receive and/or transmit information from/to the purpose-built hub, and further comprises a display configured to show an indication of the time, day, and/or date.

This system advantageously provides a means of having more than one device that is capable of delivering notifications to a user, which may operate in synchronisation. The system therefore makes it possible for users to own multiple components which may be configured to operate within a single task management system.

The auxiliary component may be configured to output an alert to tell the person living with a cognitive impairment to go to the purpose-built hub.

The alert may be an audible notification. The alert may be a visual notification. The alert may be a haptic notification.

The auxiliary component may be configured to output the alert simultaneously with an alarm of the purpose-built hub.

This advantageously allows users to receive alarms or notifications remotely from the purpose-built hub itself.

The purpose-built hub and/or auxiliary component may comprise a transmitter and receiver, between which information from a user input can be transferred. Alternatively, the hub and the auxiliary component may communicate via a wired connection.

The purpose-built hub and/or auxiliary may further comprise providing any of the features of the appliance as described above, or in the following description.

According to an example of the present disclosure, there may be provided a computer-implemented method of managing routine tasks by a person living with a cognitive, visual, or other sensory impairment, comprising the steps of storing, in a mobile computing device, one or more user inputs indicative of one or more tasks to be performed, storing, in the mobile computing device, a further user input indicative of a pre-determined time attributed to each of the one or more tasks to be performed, and outputting an alarm at each pre-determined time while simultaneously providing an indication of the respective attributed task to be performed by the person living with a cognitive, visual, or other sensory impairment.

In some arrangements, the alarm may be output by the mobile computing device, or by another device in communication with the mobile computing device, such as the task management appliance described herein. In such cases, the method may further comprise transmitting instructions to the task management appliance to output the alarm, wherein the task management appliance outputs the alarm in response to said instructions.

Yet a further example may provide a system comprising a processor, and a computer readable medium storing one or more instruction(s) arranged such that when executed the processor is caused to perform the method outlined above.

### BRIEF DESCRIPTION OF THE DRAWINGS

Further features and advantages of the present invention will be further described below, by way of example only, with reference to the accompanying drawings in which:

FIG. 1 is a schematic diagram illustrating a task management appliance according to a first aspect of the present invention;

FIG. 2A shows a rear view of the task management appliance of FIG. 1;

FIG. 2B shows a side view of the task management appliance of FIG. 1;

FIG. 3 shows a block diagram of a task management system according to a second aspect of the present invention;

FIG. 4 shows a schematic diagram illustrating an auxiliary component according to the second aspect of the present invention; and

FIG. 5 shows a block diagram of computing componentry within the components of the task management system according to the second aspect of the present invention.

### DETAILED DESCRIPTION

The term “purpose-built” is defined as being designed for a particular use. In this instance, “purpose-built” refers to being adapted for use as a task management appliance, without any other applications or software for providing other functionality installed thereon.

People often use lists as a means of identifying and tracking tasks to complete. These are often written on paper, for example, or integrated digitally in a multimedia device. While physically written or printed lists are useful, they cannot necessarily be re-used repeatedly without becoming less presentable. Similarly, multimedia devices are not purpose-built for task management and often come with several other applications or software that drains battery, increases power usage, and reduces performance of the device. Similarly, devices having other applications or functions can be confusing and difficult to use for persons with a cognitive, visual, or other sensory impairment.

One way to address this problem is to provide a purpose-built appliance which uses little power and is not packaged with other applications or software that drains battery, increases power usage and reduces the performance of the appliance. Such an appliance is useful for management of regular tasks, particularly for a person living with a cognitive impairment, who may not be able to navigate between different software applications or functions without assistance.

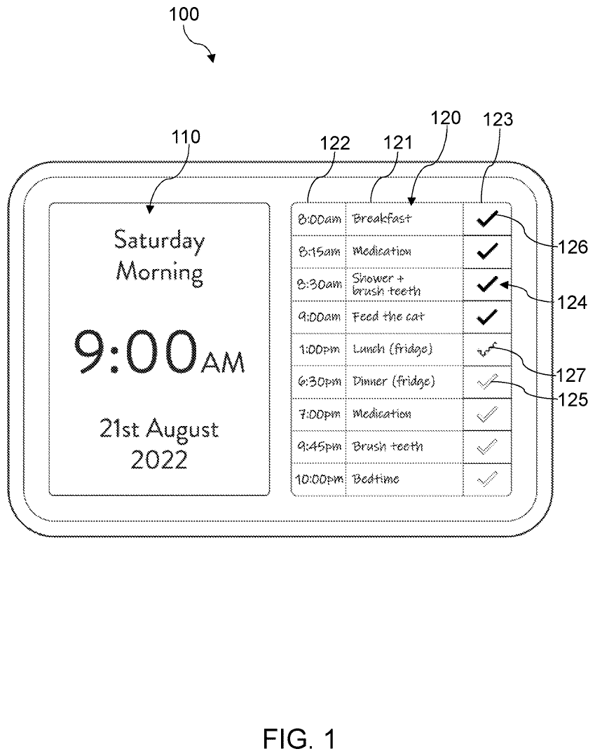

As shown in FIG. 1, there is provided a task management appliance 100. The task management appliance 100 comprises a first, time display 110 configured to show some indication of temporal data. For example, the time display 110 may be configured one or more of the time, day, and date. Users living with a cognitive impairment may find this especially useful, as they generally require indicators of the time throughout the day. The task management appliance 100 may further comprise a second, task display 120. The task display is configured to present at least one task. Preferably, the task display 120 presents a plurality of tasks.

The task management appliance 100 is configured to output an alarm at a pre-determined time while simultaneously providing an indication of the task to be performed. As can be seen in FIG. 1, each of the tasks indicated on the task display 120 is attributed a pre-determined time. The tasks may be indicated in a tabular format. For example, in FIG. 1, the tasks are shown in a task column 121. The times attributed to each of the tasks may be indicated in an adjacent schedule column 122.

At each pre-determined time, the alarm of the task management appliance 100 is output. The alarm may be output audibly, visually, or haptically. It is preferable to combine two or more of these outputs, as users living with any sensory impairments will be able to receive a notification for their task in a way which accommodates for their impairment.

Also shown in FIG. 1, the task management appliance 100 may be configured to output a variety of signals attributed to each task. In the example shown, a signal column 123 comprises a plurality of indicators 124. Each of the indicators 124 is associated with a task. In the illustration of FIG. 1, tasks are shown adjacent to the associated pre-determined time and the associated indicator 124.

The indicators 124 may be configured to output various signals. As illustrated in FIG. 1, the indicators 124 may output a first signal 125 indicating that a task is outstanding. The indicators 124 may output a second signal 127 indicating that a task is in progress. The indicators 124 may output a third signal 126 indicating that a task has been completed.

The signals output by the indicators 124 may comprise a visual signal. In the illustration of FIG. 1, the signals 125, 126, 127 are indicated in different colours to represent the various possible states of completion. It will be understood by the skilled person that, alternatively, the signals may indicate progress by other means. For example, the progress may be indicated in text, for example, in a pop-up display area provided on the task display 120.

In the embodiment illustrated, the indicators 124 output a visual signal provided by coloured LEDs. Alternatively, the indicators 124 may be configured to indicate a state of completion by being a light that is on or off. In this configuration, a third state of completion may be indicated by the LED flashing. For example, the indicators 124 being off may indicate a task which is not yet due, while an indicator 124 flashing may indicate a task which is outstanding and/or in progress, and an indicator being on may indicate a task which is complete. It will be appreciated that the state of the LED may be configured such that any visual signal may correspond to any state of progress. The indicators 124 are also provided as buttons in this embodiment, each button being associated with a task. Thus, in the embodiment shown, the LEDs illuminate the buttons associated with each task. This is optional, however, and the indicators 124 may be physically separate to the associated button or other appropriate control means.

For example, whilst a task is in progress, the first signal 125 may be a first coloured light, which may appear at a pre-determined time (i.e., when the task is due to be performed) or at a particular length of time before the task is due to be performed (e.g., 10 minutes before it is due). Once the task is in progress, the user can press the button to progress the task to “in progress”, and a second signal 127 of a second colour light (different to the first) may be provided to clearly show the task as being in progress. Once the user has completed the task, the button may be pressed again and a third signal 126 of a third colour (different to the first and second) may be provided to clearly show the task as being completed. One or more of these coloured signals may also be flashing (e.g., the “outstanding” and/or “in progress” signals may flash, whilst the “completed” signal does not flash), and may be combined with an audible alert as described above.

In the illustrated embodiment, the buttons function as a means of toggling the progress for an associated task, and thus as a means of turning off the alarm for an associated task when pressed. Preferably, the buttons are configured to cradle the finger and give good ergonomic separation between the buttons, which helps to avoid buttons from being a pressed unintentionally and the status of a task being progressed before it has been completed. By providing an ergonomic design, this also makes the device easier to use for those with reduced dexterity, or sensitivities in the finger or visual impairments. In other examples, this function may be provided by a switch, a dial, a knob, or any other appropriate control mechanism.

When the pre-determined time associated with a task triggers the associated alarm, the task is will be in an “outstanding” state of progress. When the user presses the associated button, the signal of the indicator 124 may toggle to indicate that the task is “in progress”. Upon the same button being pressed once more, the signal of the indicator 124 may toggle to indicate that the task is “complete”. This state would prevent the alarm from triggering again, for the remainder of the day. It will be understood that, in some embodiments, the signal of the indicator 124 may simply toggle between “outstanding” and complete”. Though performed with buttons in the illustrated embodiment, it will be understood that any appropriate control mechanism may be used to toggle the indicated state of progress.

It is particularly advantageous to include a signal which indicates that a task is “in progress” as persons living with cognitive impairment may be prone to forgetting that they have started a task. By recording their progress with the appliance, they are able to monitor tasks which require completion.

The tasks shown on the task display 120 may be customisable by the user. For example, the task column 121 may be provided as a series of labels, on which the user can write on. For example, the task display may comprise a paper, card, or polymer sheet on which a task can be written. Alternatively, the task column 121 may be a digital display which is configured to show user inputs that have been received electronically, for example, via a mobile computing device 150 as described further below.

This feature is advantageous as users may require reminders for different tasks to one another, and the order of those tasks may vary significantly.

Similarly, the pre-determined times attributed to the tasks may also be customisable. The schedule column 122 may therefore be configured to show user inputs. This is advantageous as it enables users to set their own notification times. As with the tasks themselves, the pre-determined times attributed to the tasks may vary significantly between users. Additionally, the timings of a user's tasks may change, which would need to be reflected on the appliance 100.

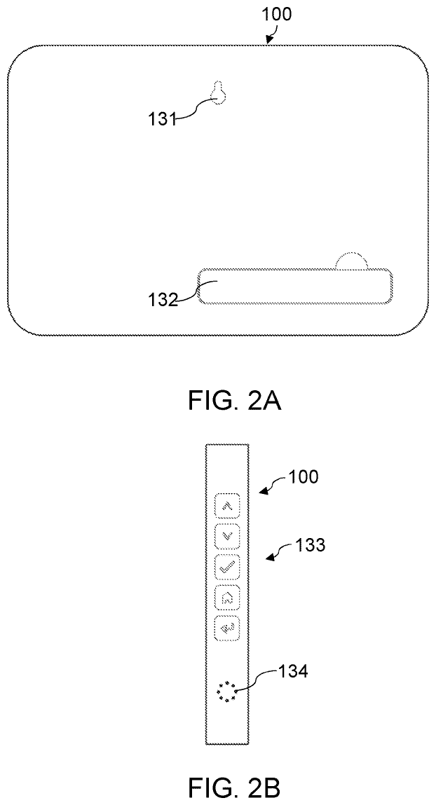

FIGS. 2A and 2B illustrate rear and side views of the task management appliance 100. The appliance 100 may comprise further accessories, such as a fixing means for fixing the appliance 100 to a surface. The fixing means may be in the form of a hook 131, for example, which may be configured to receive some form of fastener. Fasteners may take the form of screws, nuts, bolts, or any other appropriate means.

The appliance 100 may also comprise a stabilising means so that the appliance 100 may stand freely on a surface. The stabilising means may be in the form of a kick stand 132, for example, which may be configured to pivot between an open position and a closed position. In the open position 132, the kick stand is pivoted away from the appliance 100 such that it provides a support.

One or more control buttons 133 may be provided on the appliance 100. These control buttons 133 may correspond to functions of the appliance 100, such as toggling the progress of a task, stopping an alarm, or making user inputs to the tasks or their associated pre-determined times. A speaker 134 may be built-in to the task management appliance 100. This provides an integrated means of delivering audible notifications.

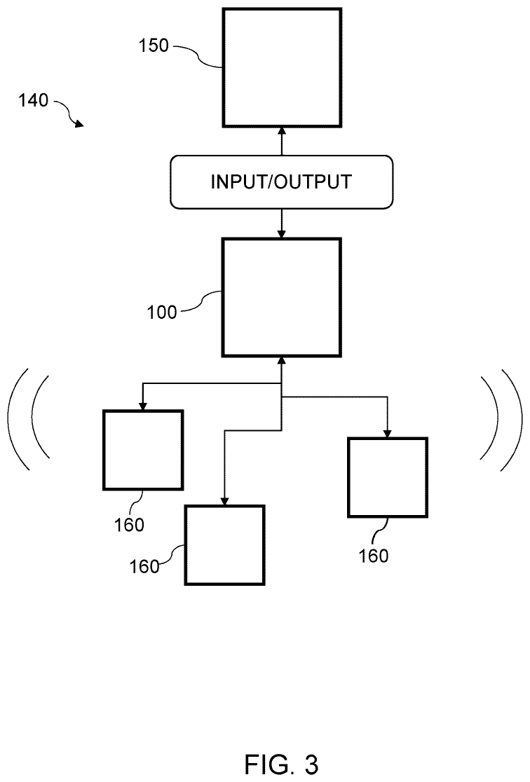

As shown in FIG. 3, the task management appliance 100 may comprise part of a task management system 140. The task management system 140 may comprise a hub, for example the task management appliance 100. The hub is generally configured to receive user input and enable customisation to the tasks and pre-determined times associated with the tasks.

The task management system 140 preferably further comprises one or more auxiliary components 160. Generally, the one or more auxiliary components 160 serve as “satellites” to the hub 100 and provide a means of monitoring tasks remotely. The hub 100 is therefore generally connected to the auxiliary components or satellites 160.

It is preferable that this connection is wireless, although it will be appreciated the hub 100 and the satellites 160 may also be connected through wired means. Such a connection may be facilitated by radio frequency (RF), for example, or any other appropriate means. In the embodiment of FIG. 3, there are three auxiliary components 160. It will be understood however that multiple auxiliary components 160 may be useful for accessibility purposes.

Thus, the hub 100 may be fitted with a transmitter and a receiver. Similarly, the satellites 160 may each be fitted with a transmitter and a receiver. This allows for the transfer of data between the devices, and for them to operate in synchronisation with one another.

Optionally, the hub 100 and the satellites 160 may further be configured to receive user input from a remote device 150. For example, if configured to receive and transmit data wirelessly, then the hub 100 and the satellites 160 may be configured to receive user inputs from a remote device comprising a mobile computing device 150. The mobile computing device 150 may comprise a computer, smartphone, tablet, a wearable computing device, or other suitable device. It will be understood that a remote device, more generally, may comprise any suitable computing device which can communicate with the hub 100 and/or the satellites 160.

In embodiments in which the hub 100 and/or the satellites 160 comprise a transmitter, the mobile computing device 150 may have application software which can receive outputs from the hub 100 and/or the satellites 160. For example, users may be able to receive notifications of alarms to their mobile computing device 150 or be able to view a real-time representation of the first display 110 and/or the second display 120 of the hub 100. Similarly, in embodiments in which the hub 100 and/or the satellites 160 comprise a receiver, the mobile computing device 150 may have application software which can deliver inputs to the hub 100 and/or the satellites 160. For example, users may be able to change the name of a task, or the pre-determined time attributed to a task, from their mobile computing device 150.

Thus, in some embodiments of the invention, the system for management of routine tasks by a user requires an application to be installed on the user's mobile computing device 150. The mobile phone application may provide the functionality needed to perform several functions. The mobile phone application is preferably capable of receiving and transmitting data via the wireless receiver and transmitter of the mobile computing device 150. Thus, the system 140 may be able to transmit an alarm at a pre-determined time via the mobile computing device 150. This is particularly useful as users who are remote from their task management system 140, or any of the components thereof, may still receive alarms remotely.

The application may also allow users to make inputs and receive outputs of whether a task is outstanding, completed, or in progress, to their mobile computing device 150. Most preferably, the application enables users to toggle the state of progress of a task remotely. For example, when a pre-determined time associated with a task triggers an associated alarm, the task is will be in an “outstanding” state of progress in the application. When the user presses a button associated with the task in the application, the progress attributed to the task may toggle to indicate that the task is “in progress”. Upon the same button being pressed once more, the progress attributed to the task may toggle further to indicate that the task is “complete”. The state of progress may be communicated with the task management system 140 such that the state of progress is reflected, in real-time, on one or more of the hub 100 and the auxiliary components 160.

The state of progress of a task may otherwise be toggled remotely by means of any separate device, application, or program which is configured to communicate with any component in the task management system 140.

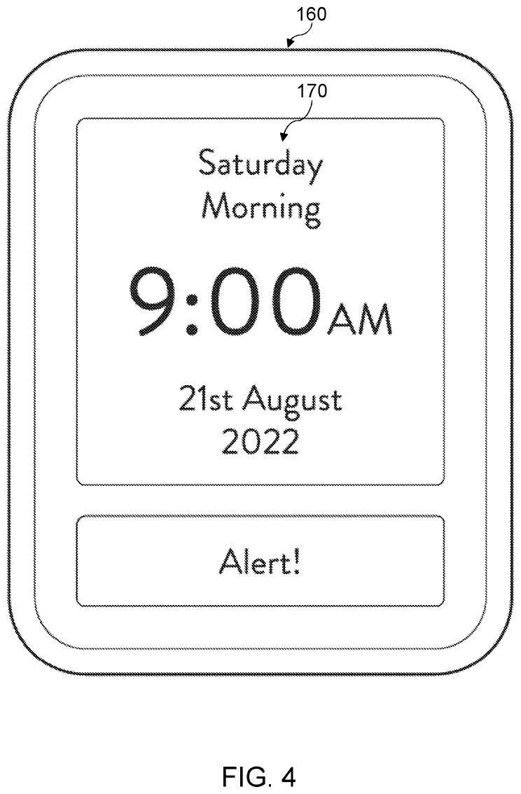

Preferably, the hub 100 and the associated auxiliary components 160 are configured to output alarms simultaneously. In the embodiment depicted in FIG. 3, user input can be made to the hub 100 which communicates with the auxiliary components 160 within the system 140. As can be seen in FIG. 4, the auxiliary components 160 preferably each comprise a display 170 configured to show an indication of temporal data. In the illustration of FIG. 4, the auxiliary component comprises a display 170 configured to show an indication of the time, day, or date. More specifically, the auxiliary component 170 is preferably configured to show the same time, day, or date as the hub 100.

The auxiliary components 160 may comprise any number of displays 170, for example a first, time display and a second, task display, similarly to the hub 100. Each auxiliary component 160 is preferably configured to direct the user back to the hub 100 to make any input, for example toggling the progress of a task in order to stop the alarm. Such a configuration allows the auxiliary components 160 to be made with significantly fewer parts, for example. By making simpler auxiliary components 160 which communicate with the hub 100, the auxiliary components 160 can be made cheaper which more easily enables users to own several of these auxiliary components 160 if necessary. The auxiliary components 160 may then be arranged in several useful locations for a user. For example, a user may prefer to place auxiliary components 160 throughout their residence, so that they receive alarm notifications in different rooms.

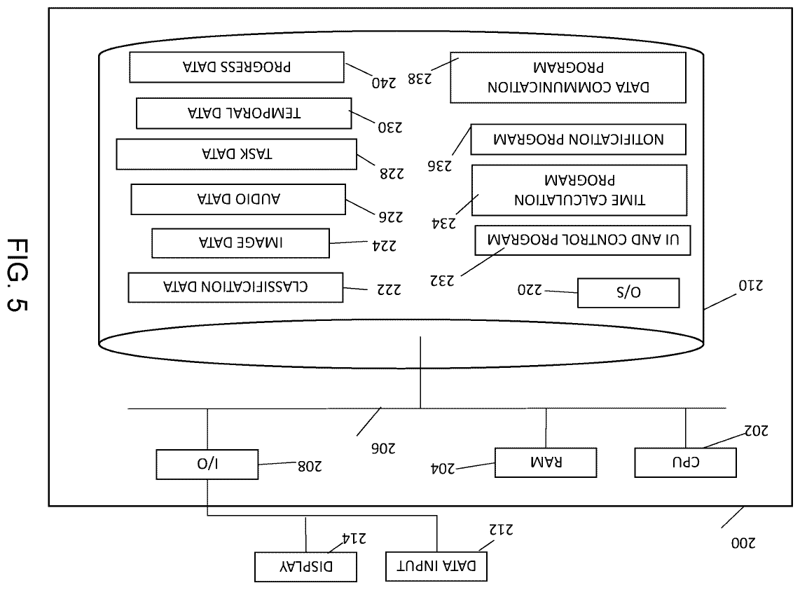

FIG. 5 illustrates an example of general computing componentry 200 that may form the platform for embodiments of the invention. For example, the computing componentry 200 may be implemented in one or more of the hub 100, the auxiliary components 160, or the mobile computing device 150. The computing componentry 200 comprises a central processing unit (CPU) 202 and a working memory 204, connected by a common bus 206, and having an input-output (I/O) interface 208 arranged to receive control inputs from a user via a device connected to a data input port 212 such as a touchscreen, push button, or other controller, and provide output information via a user interface which is displayed on a visual display device 214. The visual display device 214 may comprise, for example, the first and second displays 110, 120 of the task management appliance 100, the display 170 of the auxiliary components 160 or any visual display associated with the mobile computing device 150.

The computing componentry 200 is also provided with a computer readable storage medium 210 such as a hard disk drive (HDD), flash drive, solid state drive, or any other form of general-purpose data storage, upon which stored classification data 222, image data 224, audio data 226, task data 228, temporal data 230, progress data 240, and various programs are arranged to control the computing componentry 200 to operate in accordance with embodiments of the present invention. For example, stored on the computer readable storage medium 210 is an operating system program 220 that when run by the CPU 202 allows the system to operate. Also provided is a time calculation program 234, a notification program 236, and a data communication program 238, which implement the different aspects of the present invention when run by the CPU 202. Specifically, the time calculation program 234 is configured to receive the temporal data 222, which may comprise the present time stored in the computing componentry 200, and task data 224, which may comprise the name of a task and the pre-determined time attributed to a task, to perform the method of calculating whether or not an alarm is due. The notification program 236 is configured to receive the progress data 240 and the temporal data 230, as well as an output from the time calculation program 234, to perform the method of outputting an alarm at a pre-determined time when a task is not yet marked as complete. The data communication program 238 is configured to facilitate and process the transmission or reception of data from the various devices within the task management system 140 of FIG. 3.

In order to interface with and control the time calculation program 234, the notification program 236, and the data communication program 238, a user interface and control program 232 is also provided, that controls the computing componentry 200 to provide a visual output to the display 214, and to receive user inputs via any input means connected to the data input port 212, or any other device that may be connected to the I/O interface 208 in order to control the time calculation program 234, the notification program 236, and the data communication program 238.

Whilst the programs and data shown in FIG. 5 are described as being stored and implemented by a single computing system, it will of course be appreciated that multiple computing devices 100, 150, 160 are used to implement the embodiments of the present invention, as described with reference to FIGS. 1-4. For example, the various data may be stored on one computing system in communication with a second computing system on which the time calculation program 234, notification program 236, and data communication program 238 are implemented. Likewise, the time calculation program 234, notification program 236, and data communication program 238 may all be implemented on separate computing devices.

Various modifications, whether by way of addition, deletion and/or substitution, may be made to all of the above-described embodiments to provide further embodiments, any and/or all of which are intended to be encompassed by the appended claims.

1. A purpose-built task management appliance for managing routine tasks by a person living with a cognitive, visual, or other sensory impairment, comprising:
a first display configured to show an indication of the time, day, and/or date; and
a second display on which a plurality of tasks are presented;
wherein the purpose-built task management appliance is configured to output an alarm at a pre-determined time while simultaneously providing an indication of the task to be performed by the person living with a cognitive, visual, or other sensory impairment; and
wherein the task management appliance is configured to output signals to indicate progress, the signals being attributed to each of the plurality of tasks and comprising:
a signal indicating that a task is outstanding;
a signal indicating that a task is in progress; and
a signal indicating that a task has been completed;
wherein the signals to indicate progress are configured to be toggled by the person living with a cognitive, visual, or other sensory impairment.

2. The purpose-built task management appliance of claim 1, wherein the alarm comprises an audible, visual, and/or haptic notification.

3. The purpose-built task management appliance of claim 1, wherein at least one of the signals is a visual signal.

4. The purpose-built task management appliance of claim 1, further comprising a plurality of buttons, each button being associated with a task, the buttons being configured to turn off the alarm for an associated task when pressed.

5. The purpose-built task management appliance of claim 4, wherein the visual signal is provided on, at, or clearly corresponds to one or more of the plurality of buttons.

6. The purpose-built task management appliance of claim 3, wherein the visual signal is a color signal provided by a colored LED.

7. The purpose-built task management appliance of claim 1, wherein the second display on which a plurality of tasks can be displayed is customizable.

8. The purpose-built task management appliance of claim 1, wherein the second display on which a plurality of tasks can be displayed comprises a paper, card, or polymer sheet on which a task can be written.

9. The purpose-built task management appliance of claim 1, configured such that the pre-determined time attributed to the at least one task item is customizable.

10. The purpose-built task management appliance of claim 1, wherein the first display and/or the second display are provided on a face of the task management appliance.

11. A task management system for managing routine tasks by a person living with a cognitive, visual, or other sensory impairment, comprising a purpose-built hub and an auxiliary component;
the purpose-built hub comprising:
a display configured to show an indication of the time, day, and/or date; and
a task display on which a plurality of tasks can be displayed;
wherein the purpose-built hub is configured to output an alarm at a pre-determined time and simultaneously provide an indication of the task to be performed;
wherein the purpose-built hub and/or the auxiliary component is configured to output signals to indicate progress, the signals being attributed to each of the plurality of tasks and comprising:
a signal indicating that a task is outstanding;
a signal indicating that a task is in progress;
a signal indicating that a task has been completed;
wherein the signals to indicate progress are configured to be toggled by the person living with a cognitive, visual, or other sensory impairment; and
the auxiliary component being configured to receive and/or transmit information from/to the purpose-built hub, and further comprising
a display configured to show an indication of the time, day, and/or date.

12. The task management system of claim 11, wherein the auxiliary component is configured to output an alert to tell the person living with a cognitive impairment to go to the purpose-built hub.

13. The task management system of claim 11, wherein the alert is an audible, visual, and/or haptic notification.

14. The task management system of claim 11, wherein the auxiliary component is configured to output the alert simultaneously with an alarm of the purpose-built hub.

15. The task management system of claim 11, wherein the purpose-built hub and/or auxiliary component comprise a transmitter and receiver, between which information from a user input can be transferred.

16. The task management system of claim 11, wherein the alarm comprises an audible, visual, and/or haptic notification.

17. The task management system of claim 11, wherein at least one of the signals comprises a visual signal.

18. The task management system of claim 11, wherein the purpose-built hub and/or the auxiliary component comprises a plurality of buttons, each button being associated with a task, the buttons being configured to turn off the alarm for an associated task when pressed.

19. The task management system of claim 17, wherein the visual signal is a color signal, preferably provided by a colored LED.

20. The task management system of claim 11, wherein the task display on which a plurality of tasks can be displayed is customizable.
